(19) United States
(12) Patent Application Publication
(10) Pub. No.: US 2024/0421951 A1
(43) Pub. Date: Dec. 19, 2024

(54) ON -DEMAND POSITIONING REFERENCE SIGNAL (PRS) REQUEST METHOD AND APPARATUS, AND USER EQUIPMENT, NETWORK-SIDE DEVICE AND STORAGE MEDIUM

(71) Applicant: Beijing Xiaomi Mobile Software Co., Ltd., Beijing (CN)

(72) Inventor: Xiaolong LI, Beijing (CN)

(73) Assignee: Beijing Xiaomi Mobile Software Co., Ltd., Beijing (CN)

(21) Appl. No.: 18/703,632

(22) PCT Filed: Oct. 22, 2021
(86) PCT No.: PCT/CN2021/125851

§ 371 Date: Apr. 22, 2024

(51) Int. Cl. H04L 5/00; H04W 64/00

(52) U.S. Cl. CPC H04L 5/0048; H04W 64/00

(57) ABSTRACT

An on-demand positioning reference signal (PRS) request method. The method includes: sending at least one of an on-demand PRS request or auxiliary information to a network-side device via a mobile original-location request (MO-LR) request message; and receiving PRS configuration information sent based on the MO-LR request message by the network-side device.

### CROSS-REFERENCE TO RELATED APPLICATIONS

The present application is a U.S. National Stage of International Application No. PCT/CN2021/125851, filed on PCT Oct. 22, 2021, the contents of all of which are incorporated herein by reference in their entireties for all purposes.

### BACKGROUND

In a communication system, in order to reduce positioning delay, user equipment (UE) usually sends an on-demand positioning reference signal (PRS) request to a network-side device via a mobile original-location request (MO-LR) request message carrying the on-demand positioning reference signal (PRS) request.

### SUMMARY

The disclosure relates to the technical field of communications, in particular to an on-demand positioning reference signal (PRS) request method and apparatus, user equipment, a network-side device and a storage medium.

An on-demand positioning reference signal (PRS) request method provided by an example of a first aspect of the disclosure is performed by a user equipment (UE), and includes: sending an on-demand PRS request and/or auxiliary information to a network-side device via a mobile original-location request (MO-LR) request message; and receiving PRS configuration information sent based on the MO-LR request message by the network-side device.

An on-demand positioning reference signal (PRS) request method provided by an example of a second aspect of the disclosure is performed by a network-side device, and includes: receiving an on-demand PRS request and/or auxiliary information sent via a mobile original-location request (MO-LR) request message by UE; and sending PRS configuration information to the UE based on the MO-LR request message.

A communication apparatus provided by an example of a third aspect of the disclosure includes one or more processors and a memory, where the memory stores computer programs, and the one or more processors are collectively configured to execute the computer programs stored in the memory so as to cause the communication apparatus to perform the method provided in the example of the first aspect described herein.

A communication apparatus proposed by an example of a fourth aspect of the disclosure includes one or more processors and a memory, where the memory stores computer programs, and the one or more processors are collectively configured to execute the computer programs stored in the memory so as to cause the communication apparatus to perform the method provided in the example of the second aspect described herein.

A communication apparatus provided by an example of a fifth aspect of the disclosure includes: one or more processors and an interface circuit; the interface circuit is configured to receive code instructions and transmit the code instructions to the one or more processors; and the one or more processors are collectively configured to execute the code instructions to perform the method provided in the example of the first aspect.

A communication apparatus provided by an example of a sixth aspect of the disclosure includes: one or more processors and an interface circuit; the interface circuit is configured to receive code instructions and transmit the code instructions to the one or more processors; and the one or more processors are collectively configured to execute the code instruction to perform the method provided in the example of the second aspect.

A non-transitory computer readable storage medium provided by an example of a seventh aspect of the disclosure is configured to store instructions, where the instructions, when executed, causes the method provided in the example of the first aspect to be implemented.

A non-transitory computer readable storage medium provided by an example of an eighth aspect of the disclosure is configured to store instructions, where the instructions, when executed, causes the method provided in the example of the second aspect to be implemented.

### BRIEF DESCRIPTION OF DRAWINGS

The above and/or additional aspects and advantages of the disclosure will become apparent and easy to understand from the description of examples below in conjunction with accompanying drawings.

FIG. 1 is a schematic flow diagram of an on-demand positioning reference signal (PRS) method provided by an example of the disclosure.

FIG. 2 is a schematic flow diagram of an on-demand positioning reference signal (PRS) method provided by another example of the disclosure.

FIG. 3 is a schematic flow diagram of an on-demand positioning reference signal (PRS) method provided by another example of the disclosure.

FIG. 4 is a schematic flow diagram of an on-demand positioning reference signal (PRS) method provided by yet another example of the disclosure.

FIG. 5 is a schematic flow diagram of an on-demand positioning reference signal (PRS) method provided by yet another example of the disclosure.

FIG. 6 is a schematic flow diagram of an on-demand positioning reference signal (PRS) method provided by yet another example of the disclosure.

FIG. 7 is a schematic flow diagram of an on-demand positioning reference signal (PRS) method provided by yet another example of the disclosure.

FIG. 8 is a schematic flow diagram of an on-demand positioning reference signal (PRS) method provided by yet another example of the disclosure.

FIG. 9 is a schematic structural diagram of an on-demand positioning reference signal (PRS) apparatus provided by an example of the disclosure.

FIG. 10 is a schematic structural diagram of an on-demand positioning reference signal (PRS) apparatus provided by another example of the disclosure.

FIG. 11 is a block diagram of user equipment provided by an example of the disclosure.

FIG. 12 is a block diagram of a network-side device provided by an example of the disclosure.

### DETAILED DESCRIPTION

Examples are illustrated in detail here, instances of which are shown in the accompanying drawings. When the following descriptions concern the accompanying drawings, the same reference numerals in different accompanying drawings indicate the same or similar elements unless otherwise indicated. The implementations described in the following examples do not represent all implementations consistent with the examples of the disclosure. On the contrary, they are merely examples of apparatuses and methods that are consistent with some aspects of the examples of the disclosure as detailed in the attached claims.

The terms used in the examples of the disclosure are just for the purpose of describing specific examples and are not intended to limit the examples of the disclosure. A singular form “one” and “the” used in the examples of the disclosure and the appended claims is also intended to include a plural form, unless other meanings are clearly shown in the context. It is also to be understood that the term “and/or” used here refers to and includes any or all possible combinations of one or a plurality of associated listed items.

It is to be understood that although terms such as first, second and third may be adopted to describe various pieces of information in the examples of the disclosure, the information is not limited to the terms. These terms are merely used for distinguishing the same type of information from one another. For example, under the condition of not departing from the scope of the examples of the disclosure, first information may also be called second information, and similarly, the second information may also be called the first information. Depending on the context, for example, the word “if” and “in the case that” used here may be explained as “at the time of” or “when” or “in response to determining”.

In the related art, “how does the UE send the on-demand positioning reference signal (PRS) request via the mobile original-location request (MO-LR) request message”, “how does the MO-LR request message carry the on-demand PRS request”, and “how does the network-side device determine a reply mechanism of the on-demand PRS request in the MO-LR request message” are all technical problems that need to be solved urgently.

The disclosure provides an on-demand positioning reference signal (PRS) request method and apparatus, user equipment, a network-side device and a storage medium, so as to provide a method of sending an on-demand PRS request to the network-side device via a mobile original-location request (MO-LR) request message by the UE.

In the on-demand positioning reference signal (PRS) request method and apparatus, the user equipment, a base station and the storage medium provided in the examples of the disclosure, the UE will send the on-demand PRS request and/or the auxiliary information to the network-side device via the MO-LR request message, where the on-demand PRS request includes at least one of a PRS configuration requested by the UE, a PRS configuration identification requested by the UE, or first indication information used for indicating the UE to request the network-side device to send PRS configuration information; and the auxiliary information is used by the network-side device to determine the PRS configuration information corresponding to the UE, and then, the UE will receive the PRS configuration information correspondingly sent based on a content included in the MO-LR Request message by the network-side device. Thus, the disclosure provides a solution “requesting for the PRS configuration information from the network-side device via a way that the MO-LR request message carries the on-demand PRS request and/or the auxiliary information” and a solution “the network-side device determining a reply mechanism of the MO-LR request message based on the PRS request and/or the auxiliary information included in the MO-LR request message”, such that it may be ensured that the process “requesting for the PRS configuration information based on the MO-LR request message” may be normally achieved, which reduces positioning delay.

An on-demand positioning reference signal (PRS) request method and apparatus, user equipment, a network-side device and a storage medium provided by examples of the disclosure are described in detail below with reference to the accompanying drawings.

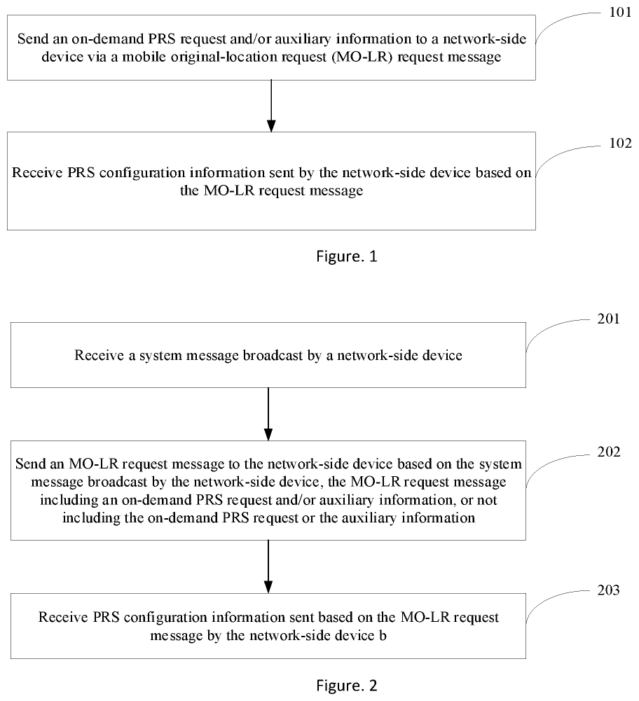

FIG. 1 is a schematic flow diagram of an on-demand positioning reference signal (PRS) request method provided by an example of the disclosure, the method is performed by the UE, and as shown in FIG. 1, the on-demand positioning reference signal (PRS) request method may include steps 101 and 102.

In step 101 an on-demand PRS request and/or auxiliary information are/is sent to a network-side device via a mobile original-location request (MO-LR) request message.

In an example of the disclosure, the UE may refer to a device providing voice and/or data connectivity for a user. The UE may communicate with one or more core networks via a radio access network (RAN), and the UE may be an Internet of Things terminal, such as a sensor device and a mobile phone (or called a “cellular” phone), and a computer with the Internet of Things terminal, for example, may be a stationary, portable, pocket, handheld, computer built-in, or vehicle-mounted apparatus. For example, the UE is a station (STA), a subscriber unit, a subscriber station, a mobile station, a mobile, a remote station, an access point, a remote terminal, an access terminal, a user terminal or a user agent. Alternatively, the UE may also be a device for an unmanned aerial vehicle. Alternatively, the UE may also be a vehicle-mounted device, for example, may be a trip computer with a wireless communication function, or a wireless terminal externally connected with the trip computer. Alternatively, the UE may also be a roadside device, for example, may be a street lamp, a signal lamp, or other roadside devices with a wireless communication function.

The network-side device may be a location management function (LMF).

Further, in an example of the disclosure, the on-demand PRS request may include at least one of the following: a PRS configuration requested by the UE; a PRS configuration identification requested by the UE; or first indication information, used for indicating the UE to request the network-side device to send PRS configuration information.

Moreover, in an example of the disclosure, the auxiliary information may be used by the network-side device to determine the PRS configuration information corresponding to the UE.

For example, in an example of the disclosure, the auxiliary information may include at least one of the following: rough location information of the UE; reference signal quality; line of sight (LOS) indication information; or non line of sight (NLOS) indication information.

In an example of the disclosure, the rough location information of the UE may be specifically: at least one of a cell ID of a cell where the UE is located, a transmission-reception point (TRP) ID or a beam ID.

In an example of the disclosure, the reference signal quality may include at least one of the following: synchronization signal-reference signal received power (SS-RSRP); synchronization signal reference signal received quality (SS-RSRQ); channel state information-reference signal received power (CSI-RSRP); channel state information-reference signal received quality (CSI-RSRQ); position reference signal-reference signal received power (PRS-RSRP); or position reference signal-reference signal received quality (PRS-RSRQ).

In an example of the disclosure, the LOS indication information may be used for indicating that a TRP signal measured by the UE is an LOS. The NLOS indication information may be used for indicating that the TRP signal measured by the UE is an NLOS.

Furthermore, in an example of the disclosure, a method of sending the on-demand PRS request and/or the auxiliary information via the MO-LR request message by the UE to the network-side device may include at least one of the following: method 1: including the on-demand PRS request and/or the auxiliary information in a long term evolution positioning protocol packet data unit (LPP PDU) of the MO-LR request message, and sending the MO-LR request message to the network-side device; or method 2: adding an information element (IE) in the MO-LR request message, using the added IE to carry the on-demand PRS request and/or the auxiliary information, and sending the MO-LR request message to the network-side device.

Then, in step 102: PRS configuration information sent based on the MO-LR request message by the network-side device is received.

In an example of the disclosure, when contents included in the MO-LR request message sent to the network-side device by the UE in step 101 are different, receiving situations of receiving the PRS configuration information by the UE are also different.

Specifically, in an example of the disclosure, receiving the PRS configuration information sent based on the MO-LR request message by the network-side device by the UE may include at least one of the following receiving situations.

Situation 1, the PRS configuration information sent by the network-side device is received, where the PRS configuration information sent by the network-side device is the same as the PRS configuration requested by the UE (for example, the UE requests for the PRS configuration information for the on-demand PRS, and the PRS configuration information sent by the network-side device is also the PRS configuration information for the on-demand PRS).

Situation 2, the PRS configuration information sent by the network-side device is received, where the PRS configuration information sent by the network-side device is different from the PRS configuration requested by the UE (for example, the UE requests for the PRS configuration information for the on-demand PRS, and the PRS configuration information sent by the network-side device is not the PRS configuration information for the on-demand PRS).

Situation 3, the PRS configuration information sent by the network-side device is not received.

“When the receiving situations of receiving the PRS configuration information by the UE is the situation 1 or situation 2 or situation 3” is introduced in detail in a subsequent example.

In addition, it needs to be noted that in an example of the disclosure, the PRS configuration information sent by the network-side device to the UE may be determined by the network-side device based on the auxiliary information included in the MO-LR request message.

Specifically speaking, a method of determining the PRS configuration information based on the auxiliary information by the network-side device may include at least one of the following: configuring a TRP near the UE for the UE according to the rough location information of the UE by the network-side device to send the PRS configuration information, for example, a proper beam may be determined to send the PRS configuration information to the UE according to a beam ID reported by the UE; or preferably configuring a TRP with an LOS for the UE according to the NLOS indication information/the LOS indication information by the network-side device; or preferably configuring a TRP with good signal quality for the UE according to the reference signal quality by the network-side device to send the PRS configuration information.

In summary, in the on-demand positioning reference signal (PRS) request method provided by the example of the disclosure, the UE will send the on-demand PRS request and/or the auxiliary information to the network-side device via the MO-LR request message, where the on-demand PRS request includes at least one of the PRS configuration requested by the UE, the PRS configuration identification requested by the UE, or the first indication information used for indicating the UE to request the network-side device to send the PRS configuration information; and the auxiliary information is used by the network-side device to determine the PRS configuration information corresponding to the UE, and then, the UE will receive the PRS configuration information correspondingly sent based on the content included in the MO-LR Request message by the network-side device. Thus, the disclosure provides a solution “requesting for the PRS configuration information from the network-side device via a way that the MO-LR request message carries the on-demand PRS request and/or the auxiliary information” and a solution “the network-side device determining a reply mechanism of the MO-LR request message based on the PRS request and/or the auxiliary information included in the MO-LR request message”, such that it may be ensured that the process “requesting for the PRS configuration information based on the MO-LR request message” may be normally achieved, which reduces positioning delay.

FIG. 2 is a schematic flow diagram of an on-demand positioning reference signal (PRS) request method provided by another example of the disclosure, the method is performed by the UE, and as shown in FIG. 2, the on-demand positioning reference signal (PRS) request method may include steps 201-203.

In step 201: a system message broadcast by the network-side device is received.

In an example of the disclosure, the system message broadcast by the network-side device may be a positioning system message, the positioning system message may include the PRS configuration information and/or the PRS configuration information for the on-demand PRS request; or the positioning system message does not include the PRS configuration information or the PRS configuration information for the on-demand PRS request.

In another example of the disclosure, the system message broadcast by the network-side device may be any system message, and the system message may include second indication information, or does not include the second indication information. The second indication information may be used for indicating the UE to be capable of sending the on-demand PRS request to the network-side device. For example, in an example of the disclosure, the second indication information may be represented by N bits, where N is a positive integer, for example, N may be 1. Moreover, for example, in an example of the disclosure, the system message including the second indication information or not including the second indication information may be the positioning system message.

Step 202: the MO-LR request message is sent to the network-side device based on the system message broadcast by the network-side device, the MO-LR request message including the on-demand PRS request and/or the auxiliary information, or the MO-LR request message not including the on-demand PRS request or the auxiliary information.

In an example of the disclosure, the UE may specifically determine whether the on-demand PRS request and/or the auxiliary information are/is included in the MO-LR request message via determining whether the system message includes the PRS configuration information and/or the PRS configuration information for the on-demand PRS.

In another example of the disclosure, the UE may specifically determine whether the on-demand PRS request and/or the auxiliary information are/is included in the MO-LR request message via determining whether the system message includes the second indication information.

Moreover, a specific method of determining whether the on-demand PRS request and/or the auxiliary information are/is included in the MO-LR request message by the UE is described in a subsequent example.

Step 203: the PRS configuration information sent based on the MO-LR request message by the network-side device is received.

Related introductions about the step 203 may refer to the example and are not repeated here in the example of the disclosure.

In summary, in the on-demand positioning reference signal (PRS) request method provided by the example of the disclosure, the UE will send the on-demand PRS request and/or the auxiliary information to the network-side device via the MO-LR request message, where the on-demand PRS request includes at least one of the PRS configuration requested by the UE, the PRS configuration identification requested by the UE, or the first indication information used for indicating the UE to request the network-side device to send the PRS configuration information; and the auxiliary information is used by the network-side device to determine the PRS configuration information corresponding to the UE, and then, the UE will receive the PRS configuration information correspondingly sent based on the content included in the MO-LR Request message by the network-side device. Thus, the disclosure provides the solution “requesting for the PRS configuration information from the network-side device via the way that the MO-LR request message carries the on-demand PRS request and/or the auxiliary information” and the solution “the network-side device determining the reply mechanism of the MO-LR request message based on the PRS request and/or the auxiliary information included in the MO-LR request message”, such that it may be ensured that the process “requesting for the PRS configuration information based on the MO-LR request message” may be achieved, which reduces positioning delay.

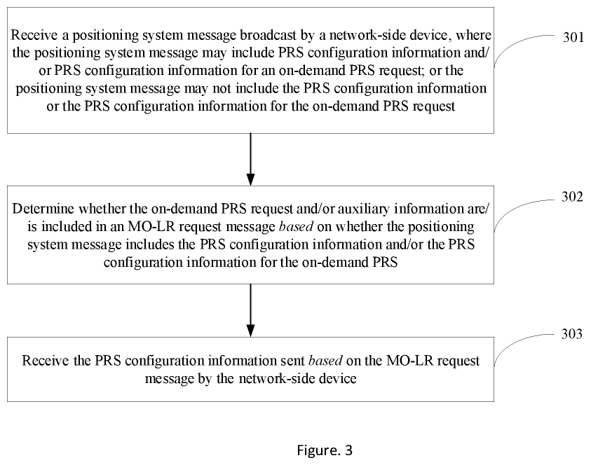

FIG. 3 is a schematic flow diagram of an on-demand positioning reference signal (PRS) request method provided by another example of the disclosure, the method is performed by the UE, and as shown in FIG. 3, the UE determines whether the on-demand PRS request and/or the auxiliary information are/is included in the MO-LR request message via determining whether the positioning system message includes the PRS configuration information and/or the PRS configuration information for the on-demand PRS. The on-demand positioning reference signal (PRS) request method includes steps 301-303.

In step 301: the positioning system message broadcast by the network-side device is received, where the positioning system message may include the PRS configuration information and/or the PRS configuration information for the on-demand PRS request; or the positioning system message may not include the PRS configuration information or the PRS configuration information for the on-demand PRS request.

Moreover, it needs to be noted that in an example of the disclosure, when the positioning system message includes the PRS configuration information for the on-demand PRS request, the positioning system message further includes a PRS configuration identification corresponding to the PRS configuration information for the on-demand PRS request. When the positioning system message does not include the PRS configuration information for the on-demand PRS request and merely includes the PRS configuration information, the positioning system message may also not include the PRS configuration identification corresponding to the PRS configuration information for the on-demand PRS request.

In step 302: whether the on-demand PRS request and/or the auxiliary information are/is included in the MO-LR request message is determined based on determining whether the positioning system message broadcast by the network-side device includes the PRS configuration information and/or the PRS configuration information for the on-demand PRS.

Related introductions about the PRS configuration information and/or the PRS configuration information for the on-demand PRS may refer to the descriptions in the example and are not repeated here in the example of the disclosure.

Moreover, in an example of the disclosure, a method of determining whether the on-demand PRS request and/or the auxiliary information are/is included in the MO-LR request message based on whether the positioning system message includes the PRS configuration information and/or the PRS configuration information for the on-demand PRS may include at least one of the following:

A) indicating that the network-side device does not send the PRS configuration information in response to determining that the positioning system message does not include the PRS configuration information, in this case, the MO-LR request message sent by the UE to the network-side device merely including the on-demand PRS request, and the on-demand PRS request merely including the first indication information, so as to request the network-side device to send the PRS configuration information.

B) indicating that the network-side device does not send the PRS configuration information and possibly does not support a function corresponding to the PRS in response to determining that the positioning system message does not include the PRS configuration information, in this case, the MO-LR request message sent by the UE to the network-side device not including the on-demand PRS request or the auxiliary information, that is, the UE does not request the network-side device to send the PRS configuration information.

C) indicating that the network-side device does not support a function corresponding to an on-demand PRS in response to determining that the positioning system message does not include the PRS configuration information for the on-demand PRS, in this case, the MO-LR request message sent by the UE to the network-side device not including the on-demand PRS request or the auxiliary information, that is, the UE does not request for the PRS configuration information for the on-demand PRS.

D) indicating that the network-side device is under sending the PRS configuration information but possibly does not support a function corresponding to the on-demand PRS in response to determining that the positioning system message includes the PRS configuration information but does not include the PRS configuration information for the on-demand PRS, in this case, the MO-LR request message sent by the UE to the network-side device including the on-demand PRS request and/or the auxiliary information, and the on-demand PRS request not needing to include the first indication information based on the network-side device having already sent the PRS configuration information. At the same time, since the positioning system message merely includes the PRS configuration information, but does not include the PRS configuration information for the on-demand PRS, the positioning system message will not include the on-demand PRS configuration identification, so that the on-demand PRS request in the MO-LR request message sent by the UE to the network-side device is supposed to merely include the PRS configuration requested by the UE, and not include the PRS configuration identification requested by the UE; and

E) indicating that the network-side device supports sending the PRS configuration information for the on-demand PRS to the UE in response to determining that the positioning system message includes the PRS configuration information for the on-demand PRS, in this case, the MO-LR request message sent by the UE to the network-side device including the on-demand PRS request and/or the auxiliary information, and the PRS configuration and/or the PRS configuration identification requested by the on-demand PRS request being supposed to be a PRS configuration and/or a PRS configuration identification corresponding to the PRS configuration information for the on-demand PRS in the positioning system message.

In addition, it needs to be noted that in an example of the disclosure, it may be considered that the UE requests for the PRS configuration information for the on-demand PRS from the network-side device in response to determining that the MO-LR request message sent by the UE to the network-side device includes the on-demand PRS request and/or the auxiliary information.

Step 303: the PRS configuration information sent based on the MO-LR request message by the network-side device is received.

In one example of the disclosure, the receiving situations of receiving the PRS configuration information by the UE in step 303 are also different in response to determining that the contents included in the MO-LR request message sent by the UE to the network-side device in step 302 are different.

Specifically, in response to determining that the MO-LR request message sent by the UE to the network-side device includes the on-demand PRS request and/or the auxiliary information in step 302, and the PRS configuration and/or the PRS configuration identification requested by the on-demand PRS request are/is the PRS configuration and/or the PRS configuration identification corresponding to the PRS configuration information for the on-demand PRS in the positioning system message, it indicates that the UE requests for the PRS configuration information for the on-demand PRS from the network-side device, the network-side device supports sending the PRS configuration information for the on-demand PRS to the UE (that is, the network-side device may meet the request of the UE), and then the network-side device provides the PRS configuration requested by the UE for the UE. Thus, the receiving situation of receiving the PRS configuration information by the UE in step 303 is supposed to be the situation 1: the PRS configuration information sent by the network-side device is received, where the PRS configuration information sent by the network-side device is the same as the PRS configuration requested by the UE.

In response to determining that the MO-LR request message sent by the UE to the network-side device includes the on-demand PRS request and/or the auxiliary information in step 302, and the on-demand PRS request includes the PRS configuration requested by the UE, it indicates that the UE requests for the PRS configuration information for the on-demand PRS from the network-side device. However, the positioning system message broadcast by the network-side device includes the PRS configuration information but does not include the PRS configuration information for the on-demand PRS. In other words, the network-side device has been sending the PRS configuration information, but possibly does not support a function corresponding to the on-demand PRS (that is, the network-side device merely can partly meet the request of the UE). Based on this, even if the network-side device does not support a function corresponding to the on-demand PRS, the network-side device may still provide a proper PRS configuration information for the UE based on the PRS configuration in the on-demand PRS request and/or the auxiliary information, but the PRS configuration information provided by the network-side device may not be used for the on-demand PRS. That is, the PRS configuration information provided by the network-side device may differ from the PRS configuration requested by the UE. For example, the PRS configuration information provided by the network-side device may be the PRS configuration information in the positioning system message broadcast by the network-side device. Thus, the receiving situation of receiving the PRS configuration information by the UE in step 303 is supposed to be the situation 2: the PRS configuration information sent by the network-side device is received, where the PRS configuration information sent by the network-side device is different from the PRS configuration requested by the UE. For example, the network-side device may send to the UE the PRS configuration information consistent with the PRS configuration information (that is, the PRS configuration information that the network-side device supports sending) included in the positioning system message.

In response to determining that the MO-LR Request message sent by the UE to the network-side device does not include the on-demand PRS request or the auxiliary information in step 302, it indicates that the UE does not request the network-side device to send the PRS configuration information. Then, the network-side device does not need to send the PRS configuration information to the UE, so that the receiving situation of receiving the PRS configuration information by the UE in step 303 is supposed to be the situation 3: the PRS configuration information sent by the network-side device is not received.

In response to determining that the MO-LR Request message sent by the UE to the network-side device merely includes the on-demand PRS request in step 302, and the on-demand PRS request merely includes the first indication information, in this case, the UE may receive the PRS configuration information sent to the UE based on the first indication information by the network-side device.

In addition, it needs to be noted that in an example of the disclosure, in response to determining that the network-side device does not support sending the PRS configuration information, that is, the network-side device merely supports other positioning technologies (such as an uplink positioning technology) not using the PRS, and in this case, the network-side device does not send the PRS configuration information to the UE regardless of the content included in the MO-LR Request message.

In summary, in the on-demand positioning reference signal (PRS) request method provided by the example of the disclosure, the UE will send the on-demand PRS request and/or the auxiliary information to the network-side device via the MO-LR request message, where the on-demand PRS request includes at least one of the PRS configuration requested by the UE, the PRS configuration identification requested by the UE, or the first indication information used for indicating the UE to request the network-side device to send the PRS configuration information; and the auxiliary information is used by the network-side device to determine the PRS configuration information corresponding to the UE, and then the UE will receive the PRS configuration information correspondingly sent based on a content included in the MO-LR Request message by the network-side device. Thus providing the solution “requesting for the PRS configuration information from the network-side device via the way that the MO-LR request message carries the on-demand PRS request and/or the auxiliary information” and the solution “the network-side device determining the reply mechanism of the MO-LR request message based on the PRS request and/or the auxiliary information included in the MO-LR request message”, such that it may be ensured that the process “requesting for the PRS configuration information based on the MO-LR request message” may be achieved, which reduces positioning delay.

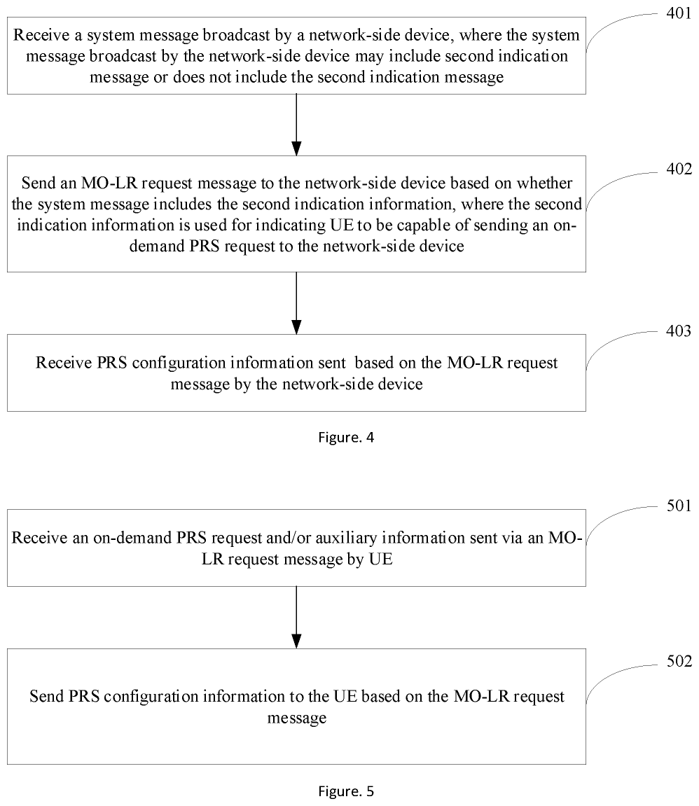

FIG. 4 is a schematic flow diagram of an on-demand positioning reference signal (PRS) request method provided by yet another example of the disclosure, the method is performed by the user equipment (UE), and as shown in FIG. 4, the on-demand positioning reference signal (PRS) request method may include steps 401-403.

In step 401: the system message broadcast by the network-side device is received. The system message broadcast by the network-side device may include the second indication information or does not include the second indication information.

In an example of the disclosure, the second indication information may be used for indicating that the UE is capable of sending the on-demand PRS request to the network-side device. For example, in an example of the disclosure, the second indication information may be represented by N bits, where N is the positive integer, for example, N may be 1.

Moreover, in an example of the disclosure, the system message may be any system message. For example, the system message may be the positioning system message.

Step 402: the MO-LR request message is sent to the network-side device based on whether the system message includes the second indication information.

In an example of the disclosure, a method of sending the MO-LR request message to the network-side device based on whether the system message includes the second indication information may include one of the following.

A) indicating that the network-side device indicates the UE to be capable of sending the on-demand PRS request to the network-side device in response to determining that the system message includes the second indication information, so considering that the network-side device supports sending the PRS configuration information (the PRS configuration information is not the PRS configuration information for the on-demand PRS) to the UE or the network-side device supports sending the PRS configuration information for the on-demand PRS to the UE, and in this case, the MO-LR request message sent to the network-side device by the UE including the on-demand PRS request and/or the auxiliary information.

B) indicating that the network-side device indicates the UE cannot send the on-demand PRS request to the network-side device in response to determining that the system message does not include the second indication information, so considering that the network-side device does not support sending the PRS configuration information to the UE, and in this case, the MO-LR request message sent to the network-side device by the UE not including the on-demand PRS request or the auxiliary information.

It needs to be noted that in an example of the disclosure, in response to determining that the MO-LR request message sent to the network-side device by the UE includes the on-demand PRS request and/or the auxiliary information, it may be considered that the UE requests for the PRS configuration information for the on-demand PRS from the network-side device.

Step 403: the PRS configuration information sent based on the MO-LR request message by the network-side device is received.

In an example of the disclosure, when the MO-LR request message includes the on-demand PRS request and/or the auxiliary information, it indicates that the UE requests for the PRS configuration information for the on-demand PRS from the network-side device. In this case, in response to determining that the current network-side device merely supports sending the PRS configuration information to the UE but does not support sending the PRS configuration information for the on-demand PRS to the UE, the receiving situation of receiving the PRS configuration information by the UE is supposed to be the situation 2: the PRS configuration information sent by the network-side device is received, where the PRS configuration information sent by the network-side device is different from the PRS configuration requested by the UE. And in response to determining that the current network-side device supports sending the PRS configuration information for the on-demand PRS to the UE, the receiving situation of receiving the PRS configuration information by the UE is supposed to be the situation 1: the PRS configuration information sent by the network-side device is received, where the PRS configuration information sent by the network-side device is the same as the PRS configuration requested by the UE. Moreover, when the MO-LR request message does not include the on-demand PRS request or the auxiliary information, in this case, the receiving situation of receiving the PRS configuration information by the UE is supposed to be the situation 3: the PRS configuration information sent by the network-side device is not received.

In summary, in the on-demand positioning reference signal (PRS) request method provided by the example of the disclosure, the UE will send the on-demand PRS request and/or the auxiliary information to the network-side device via the MO-LR request message, where the on-demand PRS request includes at least one of the PRS configuration requested by the UE, the PRS configuration identification requested by the UE, or the first indication information used for indicating the UE to request the network-side device to send the PRS configuration information; and the auxiliary information is used by the network-side device to determine the PRS configuration information corresponding to the UE, and then the UE will receive the PRS configuration information correspondingly sent based on the content included in the MO-LR Request message by the network-side device. Thus, the disclosure provides the solution “requesting for the PRS configuration information from the network-side device via the way that the MO-LR request message carries the on-demand PRS request and/or the auxiliary information” and the solution “the network-side device determining the reply mechanism of the MO-LR request message based on the PRS request and/or the auxiliary information included in the MO-LR request message”, such that it may be ensured that the process “requesting for the PRS configuration information based on the MO-LR request message” may be normally achieved, which reduces positioning delay.

FIG. 5 is a schematic flow diagram of an on-demand positioning reference signal (PRS) request method provided by yet another example of the disclosure, the method is performed by a network-side device, and as shown in FIG. 5, the on-demand positioning reference signal (PRS) request method may include steps 501 and 502.

In step 501: an on-demand PRS request and/or auxiliary information sent via an MO-LR request message by UE are/is received.

In an example of the disclosure, the on-demand PRS request may include at least one of the following: a PRS configuration requested by the UE; a PRS configuration identification requested by the UE; or first indication information, used for indicating the UE to request the network-side device to send PRS configuration information.

Moreover, in an example of the disclosure, the auxiliary information is used by the network-side device to determine the PRS configuration information corresponding to the UE.

The auxiliary information may include at least one of the following: rough location information of the UE; reference signal quality; LOS indication information; or NLOS indication information.

In an example of the disclosure, the rough location information of the UE may be at least one of a cell ID of a cell where the UE is located, a TRP ID or a beam ID.

In an example of the disclosure, the reference signal quality may include at least one of the following: SS-RSRP; SS-RSRQ; CSI-RSRP; CSI-RSRQ; PRS-RSRP; or PRS-RSRQ.

In an example of the disclosure, the LOS indication information may be used for indicating that a TRP signal measured by the UE is an LOS.

The NLOS indication information may be used for indicating that the TRP signal measured by the UE is an NLOS.

Moreover, in an example of the disclosure, a mode of receiving the on-demand PRS request and/or the auxiliary information sent via the MO-LR request message by the UE may include at least one of the following: method 1: receiving the on-demand PRS request and/or the auxiliary information in an LPP PDU included in the MO-LR request message; or method 2: receiving the on-demand PRS request and/or the auxiliary information in an added IE carried in the MO-LR request message.

Further, in an example of the disclosure, the method of receiving the on-demand PRS request and/or the auxiliary information sent via the MO-LR request message by the UE may include at least one of the following: receiving the on-demand PRS request sent via the MO-LR request message by the UE, where the on-demand PRS request merely includes the first indication information; receiving the on-demand PRS request and/or the auxiliary information sent via f the MO-LR request message by the UE, where the on-demand PRS request merely includes the PRS configuration requested by the UE; receiving the on-demand PRS request and/or the auxiliary information sent via the MO-LR request message by the UE, where the PRS configuration and/or the PRS configuration identification requested by the on-demand PRS request are/is a PRS configuration and/or a PRS configuration identification corresponding to PRS configuration information for an on-demand PRS in a system message broadcast by the network-side device; or receiving the MO-LR request message sent by the UE, where the MO-LR request message does not include the on-demand PRS request or the auxiliary information.

A detailed description of any cases in which the method may occur may be described with reference to the included examples, which are not repeated here in the example of the disclosure.

Step 502: the PRS configuration information is sent to the UE based on the MO-LR request message.

In an example of the disclosure, receiving the on-demand PRS request and/or the auxiliary information sent via the MO-LR request message by the UE includes at least one of the following.

A) sending the PRS configuration information the same as the PRS configuration requested by the UE to the UE by the network-side device in response to determining that the MO-LR request message sent by the UE to the network-side device includes the on-demand PRS request and/or the auxiliary information, and the PRS configuration and/or the PRS configuration identification requested by the on-demand PRS request are/is the PRS configuration and/or the PRS configuration identification corresponding to the PRS configuration information for the on-demand PRS in the system message.

B) sending the PRS configuration information to the UE by the network-side device in response to determining that the MO-LR request message sent by the UE to the network-side device includes the on-demand PRS request and/or the auxiliary information, and the on-demand PRS request merely includes the PRS configuration requested by the UE, where the PRS configuration information sent by the network-side device to the UE is different from the PRS configuration requested by the UE.

C) sending the PRS configuration information to the UE based on the first indication information by the network-side device in response to determining that the MO-LR request message sent by the UE to the network-side device merely includes the on-demand PRS request, and the on-demand PRS request includes the first indication information.

D) skipping sending the PRS configuration information to the UE by the network-side device in response to determining that the network-side device does not support sending the PRS configuration information.

In addition, it needs to be noted that in an example of the disclosure, the PRS configuration information sent by the network-side device to the UE may be determined based on the auxiliary information included in the MO-LR request message by the network-side device.

Specifically speaking, a method of determining the PRS configuration information based on the auxiliary information by the network-side device may include at least one of the following: configuring a TRP near the UE for the UE according to the rough location information of the UE by the network-side device to send the PRS configuration information, for example, a proper beam may be determined to send the PRS configuration information to the UE according to a beam ID reported by the UE; preferably configuring a TRP with the LOS for the UE according to the NLOS indication information/the LOS indication information by the network-side device; or preferably configuring a TRP with good signal quality for the UE according to the reference signal quality by the network-side device to send the PRS configuration information.

A detailed description about the method may refer to the included examples, and are not repeated here in the example of the disclosure.

In summary, in the on-demand positioning reference signal (PRS) request method provided by the example of the disclosure, the UE will send the on-demand PRS request and/or the auxiliary information to the network-side device via the MO-LR request message, where the on-demand PRS request includes at least one of the PRS configuration requested by the UE, the PRS configuration identification requested by the UE, or the first indication information used for indicating the UE to request the network-side device to send the PRS configuration information. The auxiliary information is used by the network-side device to determine the PRS configuration information corresponding to the UE, and then the UE will receive the PRS configuration information correspondingly sent based on the content included in the MO-LR Request message by the network-side device. Thus, the disclosure provides the solution “requesting for the PRS configuration information from the network-side device via the way that the MO-LR request message carries the on-demand PRS request and/or the auxiliary information” and the solution “the network-side device determining a reply mechanism of the MO-LR request message based on the PRS request and/or the auxiliary information included in the MO-LR request message”, such that it may be ensured that the process “requesting for the PRS configuration information based on the MO-LR request message” may be normally achieved, which reduces positioning delay.

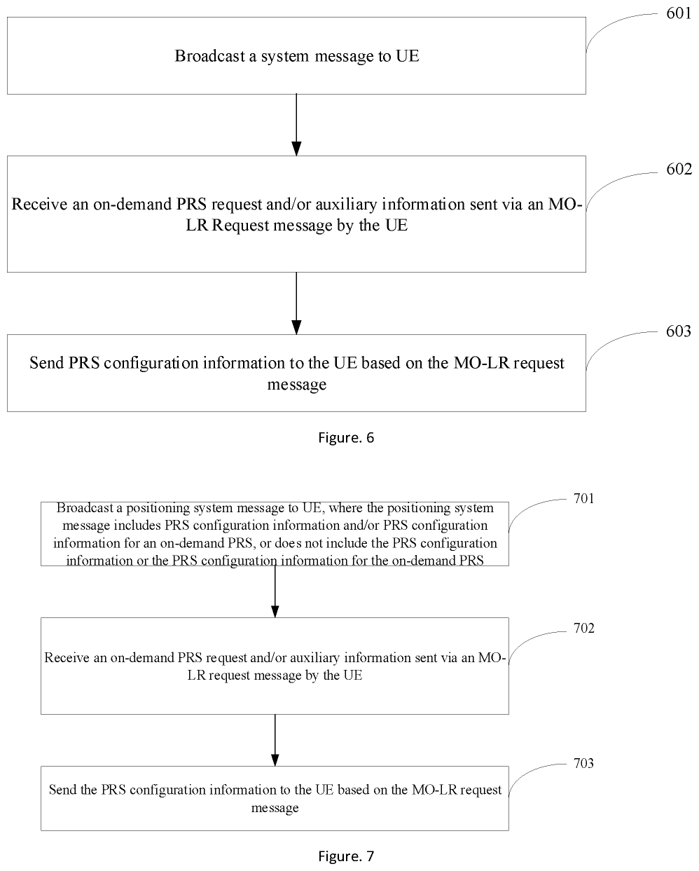

FIG. 6 is a schematic flow diagram of an on-demand positioning reference signal (PRS) request method provided by yet another example of the disclosure, the method is performed by the network-side device, and as shown in FIG. 6, the on-demand positioning reference signal (PRS) request method may include steps 601-603.

In step 601: the system message is broadcast to the UE.

In an example of the disclosure, the system message may be a positioning system message, and the positioning system message may include PRS configuration information and/or the PRS configuration information for the on-demand PRS, or the positioning system message does not include the PRS configuration information or the PRS configuration information for the on-demand PRS.

In another example of the disclosure, the system message may be any system message, and the system message may include second indication information, or does not include the second indication information. The second indication information may be used for indicating the UE to be capable of sending the on-demand PRS request to the network-side device. For example, in an example of the disclosure, the second indication information may be represented by N bits, where N is the positive integer, for example, N may be 1. Moreover, for example, in one example of the disclosure, the system message including the second indication information or not including the second indication information may be the positioning system message.

Step 602: the on-demand PRS request and/or the auxiliary information sent via the MO-LR request message by the UE are/is received.

In an example of the disclosure, the UE may specifically determine whether the on-demand PRS request and/or the auxiliary information are/is included in the MO-LR request message via determining whether the system message includes the PRS configuration information and/or the PRS configuration information for the on-demand PRS.

In another example of the disclosure, the UE may specifically determine whether the on-demand PRS request and/or the auxiliary information are/is included in the MO-LR request message via determining whether the system message includes the second indication information.

Step 603: the PRS configuration information is sent to the UE based on the MO-LR request message.

Related descriptions about steps 602 to 603 may refer to the descriptions of the included example, and are not repeated here in the disclosure.

In summary, in the on-demand positioning reference signal (PRS) request method provided by the example of the disclosure, the UE will send the on-demand PRS request and/or the auxiliary information to the network-side device via the MO-LR request message, where the on-demand PRS request includes at least one of the PRS configuration requested by the UE, the PRS configuration identification requested by the UE, or the first indication information used for indicating the UE to request the network-side device to send the PRS configuration information; and the auxiliary information is used by the network-side device to determine the PRS configuration information corresponding to the UE, and then the UE will receive the PRS configuration information correspondingly sent based on the content included in the MO-LR Request message by the network-side device. Thus, the disclosure provides the solution “requesting for the PRS configuration information from the network-side device via the way that the MO-LR request message carries the on-demand PRS request and/or the auxiliary information” and the solution “the network-side device determining the reply mechanism of the MO-LR request message based on the PRS request and/or the auxiliary information included in the MO-LR request message”, such that it may be ensured that the process “requesting for the PRS configuration information based on the MO-LR request message” may be normally achieved, which reduces positioning delay.

FIG. 7 is a schematic flow diagram of an on-demand positioning reference signal (PRS) request method provided by yet another example of the disclosure, the method is performed by the network-side device, and as shown in FIG. 7, the on-demand positioning reference signal (PRS) request method may include steps 701-703.

In step 701: the positioning system message is broadcast to the UE, where the positioning system message may include the PRS configuration information and/or the PRS configuration information for the on-demand PRS, or the positioning system message does not include the PRS configuration information or the PRS configuration information for the on-demand PRS.

In step 702: the on-demand PRS request and/or the auxiliary information sent via the MO-LR request message by the UE are/is received.

In an example of the disclosure, the UE may specifically determine whether the on-demand PRS request and/or the auxiliary information are/is included in the MO-LR request message via determining whether the positioning system message includes the PRS configuration information and/or the PRS configuration information for the on-demand PRS.

In another example of the disclosure, the UE may specifically determine whether the on-demand PRS request and/or the auxiliary information are/is included in the MO-LR request message via determining whether the positioning system message includes the second indication information.

Step 703: the PRS configuration information is sent to the UE based on the MO-LR request message.

Related descriptions about steps 702 to 703 may refer to the descriptions of the included examples, and are not repeated here in the disclosure.

In summary, in the on-demand positioning reference signal (PRS) request method provided by the example of the disclosure, the UE will send the on-demand PRS request and/or the auxiliary information to the network-side device via the MO-LR request message, where the on-demand PRS request includes at least one of the PRS configuration requested by the UE, the PRS configuration identification requested by the UE, or the first indication information used for indicating the UE to request the network-side device to send the PRS configuration information; and the auxiliary information is used by the network-side device to determine the PRS configuration information corresponding to the UE, and then the UE will receive the PRS configuration information correspondingly sent based on the content included in the MO-LR Request message by the network-side device. Thus, the disclosure provides the solution “requesting for the PRS configuration information from the network-side device via the way that the MO-LR request message carries the on-demand PRS request and/or the auxiliary information” and the solution “the network-side device determining the reply mechanism of the MO-LR request message based on the PRS request and/or the auxiliary information included in the MO-LR request message”, such that it may be ensured that the process “requesting for the PRS configuration information based on the MO-LR request message” may be normally achieved, which reduces positioning delay.

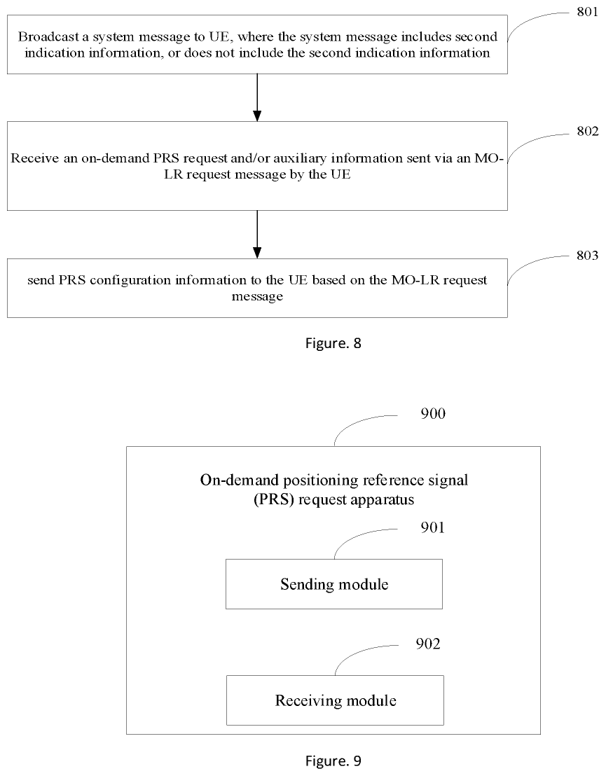

FIG. 8 is a schematic flow diagram of an on-demand positioning reference signal (PRS) request method provided by yet another example of the disclosure, the method is performed by the network-side device, and as shown in FIG. 8, the on-demand positioning reference signal (PRS) request method may include steps 801-803.

In step 801: the system message is broadcast to the UE. The system message may include the second indication information, or does not include the second indication information. The second indication information may be used for indicating the UE to be capable of sending the on-demand PRS request to the network-side device. For example, in an example of the disclosure, the second indication information may be represented by N bits, where N is the positive integer, for example, N may be 1.

In an example of the disclosure, the system message may be any system message. For example, the system message may be the positioning system message.

Step 802: the on-demand PRS request and/or the auxiliary information sent via the MO-LR request message by the UE are/is received.

In an example of the disclosure, the UE may specifically determine whether the on-demand PRS request and/or the auxiliary information are/is included in the MO-LR request message via determining whether the system message includes the PRS configuration information and/or the PRS configuration information for the on-demand PRS.

In another example of the disclosure, the UE may specifically determine whether the on-demand PRS request and/or the auxiliary information are/is included in the MO-LR request message via determining whether the system message includes the second indication information.

Step 803: the PRS configuration information is sent to the UE based on the MO-LR request message.

Related descriptions about steps 802 to 803 may refer to the descriptions of the included examples, and are not repeated here in the disclosure.

In summary, in the on-demand positioning reference signal (PRS) request method provided by the example of the disclosure, the UE will send the on-demand PRS request and/or the auxiliary information to the network-side device via the MO-LR request message, where the on-demand PRS request includes at least one of the PRS configuration requested by the UE, the PRS configuration identification requested by the UE, or the first indication information used for indicating the UE to request the network-side device to send the PRS configuration information. The auxiliary information is used by the network-side device to determine the PRS configuration information corresponding to the UE, and then the UE will receive the PRS configuration information correspondingly sent based on the content included in the MO-LR Request message by the network-side device. Thus, the disclosure provides the solution “requesting for the PRS configuration information from the network-side device via the way that the MO-LR request message carries the on-demand PRS request and/or the auxiliary information” and the solution “the network-side device determining the reply mechanism of the MO-LR request message based on the PRS request and/or the auxiliary information included in the MO-LR request message”, such that it may be ensured that the process “requesting for the PRS configuration information based on the MO-LR request message” may be achieved, which reduces positioning delay.

FIG. 9 is a schematic structural diagram of an on-demand positioning reference signal (PRS) request apparatus 900 provided by an example of the disclosure, performed by the UE, and as shown in FIG. 9, the on-demand positioning reference signal (PRS) request apparatus 900 may include a sending module 901 and a receiving module 902.

The sending module 901 is configured to send an on-demand PRS request and/or auxiliary information to a network-side device via a mobile original-location request (MO-LR) request message.

The receiving module 902 is configured to receive PRS configuration information sent based on the MO-LR request message by the network-side device.

In summary, in the on-demand positioning reference signal (PRS) request apparatus provided by the example of the disclosure, the UE will send the on-demand PRS request and/or the auxiliary information to the network-side device via the MO-LR request message, where the on-demand PRS request includes at least one of a PRS configuration requested by the UE, a PRS configuration identification requested by the UE, or first indication information used for indicating the UE to request the network-side device to send the PRS configuration information. The auxiliary information is used by the network-side device to determine the PRS configuration information corresponding to the UE, and then the UE will receive the PRS configuration information correspondingly sent based on a content included in the MO-LR Request message by the network-side device. Thus, the disclosure provides a solution “requesting for the PRS configuration information from the network-side device via the way that the MO-LR request message carries the on-demand PRS request and/or the auxiliary information” and a solution “the network-side device determining a reply mechanism of the MO-LR request message based on the PRS request and/or the auxiliary information included in the MO-LR request message”, such that it may be ensured that the process “requesting for the PRS configuration information based on the MO-LR request message” may be normally achieved, which reduces positioning delay.

Alternatively or additionally, in an example of the disclosure, the on-demand PRS request includes at least one of the following: the PRS configuration requested by the UE; the PRS configuration identification requested by the UE; or the first indication information, used for indicating the UE to request the network-side device to send the PRS configuration information.

Alternatively or additionally, in an example of the disclosure, the auxiliary information is used by the network-side device to determine the PRS configuration information corresponding to the UE.

The auxiliary information includes at least one of the following: rough location information of the UE; reference signal quality; line of sight (LOS) indication information; or non line of sight (NLOS) indication information.

Alternatively or additionally, in an example of the disclosure, the sending module 901 is further configured to: send the MO-LR request message to the network-side device based on a system message broadcast by the network-side device, where the MO-LR request message includes the on-demand PRS request and/or the auxiliary information; or the MO-LR request message does not include the on-demand PRS request or the auxiliary information.

Alternatively or additionally, in an example of the disclosure, the sending module 901 is further configured to: determine whether the on-demand PRS request and/or the auxiliary information are/is included in the MO-LR request message based on whether a positioning system message broadcast by the network-side device includes the PRS configuration information and/or the PRS configuration information for the on-demand PRS.

Alternatively or additionally, in an example of the disclosure, the sending module 901 is further configured to: the MO-LR request message sent by the UE to the network-side device merely includes the on-demand PRS request in response to determining that the positioning system message does not include the PRS configuration information, where the on-demand PRS request includes the first indication information; the MO-LR request message sent by the UE to the network-side device does not include the on-demand PRS request or the auxiliary information in response to determining that the positioning system message does not include the PRS configuration information; the MO-LR request message sent by the UE to the network-side device does not include the on-demand PRS request or the auxiliary information in response to determining that the positioning system message does not include the PRS configuration information for the on-demand PRS; the MO-LR request message sent by the UE to the network-side device includes the on-demand PRS request and/or the auxiliary information in response to determining that the positioning system message includes the PRS configuration information, but the positioning system message does not include the PRS configuration information for the on-demand PRS, where the on-demand PRS request includes the PRS configuration requested by the UE; and the MO-LR request message sent by the UE to the network-side device includes the on-demand PRS request and/or the auxiliary information in response to determining that the positioning system message includes the PRS configuration information for the on-demand PRS.

Alternatively or additionally, in an example of the disclosure, the PRS configuration and/or the PRS configuration identification requested by the on-demand PRS request are/is a PRS configuration and/or a PRS configuration identification corresponding to the PRS configuration information for the on-demand PRS in the system message in response to determining that the MO-LR request message sent by the UE to the network-side device includes the on-demand PRS request and/or the auxiliary information.

Alternatively or additionally, in an example of the disclosure, the sending module 901 is further configured to: send the MO-LR request message to the network-side device based on whether the system message includes the second indication information, where the second indication information is used for indicating the UE to be capable of sending the on-demand PRS request to the network-side device. Where the MO-LR request message sent by the UE to the network-side device includes the on-demand PRS request and/or the auxiliary information in response to determining that the system message includes the second indication information; and the MO-LR request message sent by the UE to the network-side device does not include the on-demand PRS request or the auxiliary information in response to determining that the system message does not include the second indication information.

Alternatively or additionally, in an example of the disclosure, the system message is the positioning system message.

Alternatively or additionally, in an example of the disclosure, the sending module 901 is further configured to: include the on-demand PRS request and/or the auxiliary information in a long term evolution positioning protocol packet data unit (LPP PDU) of the MO-LR request message, and send the MO-LR request message to the network-side device; or add an information element (IE) in the MO-LR request message, use the added IE to carry the on-demand PRS request and/or the auxiliary information, and send the MO-LR request message to the network-side device.

Alternatively or additionally, in an example of the disclosure, the receiving module 902 is further configured to: receive the PRS configuration information sent by the network-side device, where the PRS configuration information is the same as the PRS configuration requested by the UE; receive the PRS configuration information sent by the network-side device, where the PRS configuration information is different from the PRS configuration requested by the UE; and not receive the PRS configuration information sent by the network-side device.

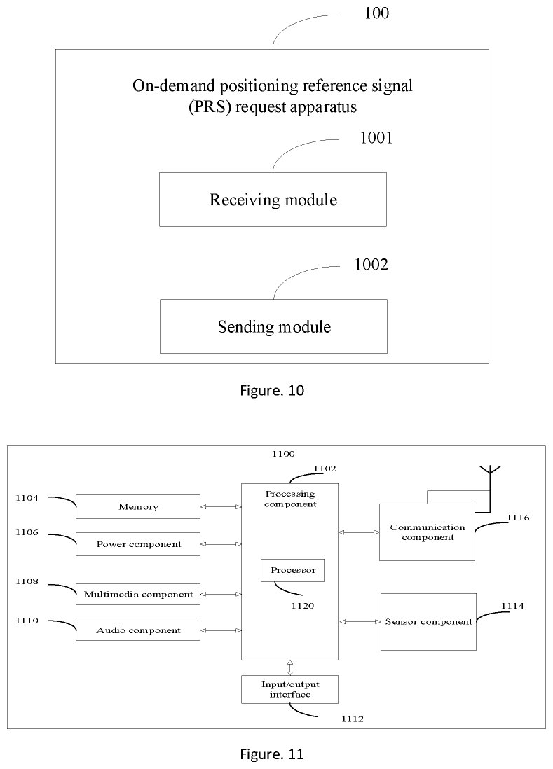

FIG. 10 is a schematic structural diagram of an on-demand positioning reference signal (PRS) request apparatus 100 provided by another example of the disclosure, performed by a network-side device, and as shown in FIG. 10, the on-demand positioning reference signal (PRS) request apparatus 100 may include a receiving module 1001 and a sending module 1002.

The receiving module 1001 is configured to receive an on-demand PRS request and/or auxiliary information sent via an MO-LR request message by UE.

The sending module 1002 is configured to send PRS configuration information to the UE based on the MO-LR request message.

In summary, in the on-demand positioning reference signal (PRS) request apparatus provided by the example of the disclosure, the UE will send the on-demand PRS request and/or the auxiliary information to the network-side device via the MO-LR request message, where the on-demand PRS request includes at least one of a PRS configuration requested by the UE, a PRS configuration identification requested by the UE, or first indication information used for indicating the UE to request the network-side device to send the PRS configuration information. The auxiliary information is used by the network-side device to determine the PRS configuration information corresponding to the UE, and then the UE will receive the PRS configuration information correspondingly sent based on a content included in the MO-LR Request message by the network-side device. Thus, the disclosure provides a solution “requesting for the PRS configuration information from the network-side device via the way that the MO-LR request message carries the on-demand PRS request and/or the auxiliary information” and a solution “the network-side device determining a reply mechanism of the MO-LR request message based on the PRS request and/or the auxiliary information included in the MO-LR request message”, such that it may be ensured that the process “requesting for the PRS configuration information based on the MO-LR request message” may be normally achieved, which reduces positioning delay.

Alternatively or additionally, in an example of the disclosure, the on-demand PRS request includes at least one of the following: the PRS configuration requested by the UE; the PRS configuration identification requested by the UE; or the first indication information, used for indicating the UE to request the network-side device to send the PRS configuration information.

Alternatively or additionally, in an example of the disclosure, the auxiliary information is used by the network-side device to determine the PRS configuration information corresponding to the UE.

The auxiliary information includes at least one of the following: rough location information of the UE; reference signal quality; line of sight (LOS) indication information; or non line of sight (NLOS) indication information.

Alternatively or additionally, in an example of the disclosure, the apparatus 100 is further configured to: broadcast a positioning system message to the UE, where the positioning system message includes PRS configuration information and/or PRS configuration information for an on-demand PRS, or the positioning system message does not include the PRS configuration information or the PRS configuration information for the on-demand PRS.

Alternatively or additionally, in an example of the disclosure, the receiving module 1001 is further configured to: receive the on-demand PRS request sent via the MO-LR request message by the UE, where the on-demand PRS request includes the first indication information.

Alternatively or additionally, in an example of the disclosure, the receiving module 1001 is further configured to: receive the on-demand PRS request and/or the auxiliary information sent via the MO-LR Request message by the UE in response to determining that the positioning system message broadcast by the network-side device includes the PRS configuration information for the on-demand PRS. Where the PRS configuration and/or the PRS configuration identification requested by the on-demand PRS request are/is a PRS configuration and/or a PRS configuration identification corresponding to the PRS configuration information for the on-demand PRS in the positioning system message broadcast by the network-side device.

Alternatively or additionally, in an example of the disclosure, the receiving module 1001 is further configured to: receive the on-demand PRS request and/or the auxiliary information included in an LPP PDU of the MO-LR request message; and receive the on-demand PRS request and/or the auxiliary information carried in an added IE of the MO-LR request message.

Alternatively or additionally, in an example of the disclosure, the sending module 1002 is further configured to: send the PRS configuration information the same as the PRS configuration requested by the UE to the UE in response to determining that the MO-LR request message sent by the UE to the network-side device includes the on-demand PRS request and/or the auxiliary information, and the PRS configuration and/or the PRS configuration identification requested by the on-demand PRS request are/is the PRS configuration and/or the PRS configuration identification corresponding to the PRS configuration information for the on-demand PRS in the positioning system message; send the PRS configuration information to the UE in response to determining that the MO-LR request message sent by the UE to the network-side device includes the on-demand PRS request and/or the auxiliary information, and the on-demand PRS request merely includes the PRS configuration requested by the UE, where the PRS configuration information sent by the network-side device to the UE is different from the PRS configuration requested by the UE; send the PRS configuration information to the UE based on the first indication information in response to determining that the MO-LR request message sent by the UE to the network-side device merely includes the on-demand PRS request, and the on-demand PRS request includes the first indication information; and skip sending the PRS configuration information to the UE in response to determining that the network-side device does not support sending the PRS configuration information.

Alternatively or additionally, in an example of the disclosure, the apparatus 100 is further configured to: broadcast the system message to the UE, where the system message includes second indication information, or the system message does not include the second indication information, and the second indication information is used for indicating the UE to be capable of sending the on-demand PRS request to the network-side device.

Alternatively or additionally, in an example of the disclosure, the system message is the positioning system message.

FIG. 11 is a block diagram of user equipment (UE) 1100 provided by an example of the disclosure. For example, the UE 1100 may be a mobile phone, a computer, a digital broadcasting terminal device, a messaging device, a game console, a tablet device, a medical device, a fitness device, a personal digital assistant, etc.

Referring to FIG. 11, the UE 1100 may include at least one of the following components: a processing component 1102, a memory 1104, a power component 1106, a multimedia component 1108, an audio component 1110, an input/output (I/O) interface 1112, a sensor component 1114, or a communication component 1116.

The processing component 1102 typically controls an overall operation of the UE 1100, such as operations associated with display, telephone call, data communication, a camera operation, and a recording operation. The processing component 1102 may include at least one processor 1120 to execute instructions to complete all or part of the steps of the included methods. In addition, the processing component 1102 may include at least one module to facilitate interactions between the processing component 1102 and other components. For example, the processing component 1102 may include a multimedia module to facilitate the interaction between the multimedia component 1108 and the processing component 1102.

The memory 1104 is configured to store various types of data to support operations on the UE 1100. Examples of such data include instructions of any application program or method for operating on the UE 1100, contact data, phone book data, messages, pictures, videos, etc. The memory 1104 may be implemented by any type of volatile or non-volatile storage device or a combination of them, such as a static random-access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk or optical disc.

The power component 1106 provides power for the various components of the UE 1100. The power component 1106 may include a power management system, at least one power supply, and other components associated with generating, managing, and distributing power for the UE 1100.

The multimedia component 1108 includes a screen providing an output interface between the UE 1100 and a user. In some examples, the screen may include a liquid crystal display (LCD) and a touch panel (TP). In response to determining that the screen includes the touch panel, the screen may be implemented as a touch screen to receive input signals from the user. The touch panel includes at least one touch sensor to sense touching, swiping, and gestures on the touch panel. The touch sensor may not only sense a boundary of a touch or swiping action, but also detect wakeup time and pressure associated with the touch or swiping action. In some examples, the multimedia component 1108 includes a front camera and/or a rear camera. When the UE 1100 is in an operation mode, such as a shooting mode or video mode, the front camera and/or the rear camera may receive external multimedia data. Each front camera and each rear camera may be a fixed optical lens system or have a focal length and optical zoom capability.

The audio component 1110 is configured to output and/or input audio signals. For example, the audio component 1110 includes a microphone (MIC) that is configured to receive external audio signals when the UE 1100 is in an operation mode, such as a call mode, a recording mode, and a speech recognition mode. The received audio signals may be further stored in the memory 1104 or sent via the communication component 1116. In some examples, the audio component 1110 also includes a speaker for outputting the audio signals.

The I/O interface 1112 provides an interface between the processing component 1102 and a peripheral interface module, and the peripheral interface module may be a keyboard, a click wheel, buttons, etc. These buttons may include but are not limited to a home button, a volume button, a start button, and a lock button.

The sensor component 1114 includes at least one sensor configured to provide a status assessment of all aspects for the UE 1100. For example, the sensor component 1114 may detect an on/off state of the UE 1100, and relative positioning of the components, for example, the components are a display and a keypad of the UE 1100, and the sensor component 1114 may also detect the change in the position of the UE 1100 or one of the components of the UE 1100, presence or absence of contact between the user and the UE 1100, an orientation or acceleration/deceleration of the UE 1100 and a temperature change of the UE 1100. The sensor component 1114 may include a proximity sensor configured to detect presence of nearby objects without any physical contact. The sensor component 1114 may also include an optical sensor, such as a CMOS or CCD image sensor for use in imaging applications. In some examples, the sensor component 1114 may also include an acceleration sensor, a gyroscope sensor, a magnetic sensor, a pressure sensor or a temperature sensor.

The communication component 1116 is configured to facilitate wired or wireless communication between the UE 1100 and other devices. The UE 1100 may access a wireless network based on a communication standard, such as WiFi, 2G or 3G, or a combination of them. In an example, the communication component 1116 receives broadcast signals or broadcast-related information from an external broadcast management system via a broadcast channel. In an example, the communication component 1116 also includes a near-field communication (NFC) module to promote short-range communication. For example, the NFC module may be implemented based on a radio frequency identification (RFID) technology, an infrared data association (IrDA) technology, an ultra-wide band (UWB) technology, a bluetooth (BT) technology and other technologies.

In the example, the UE 1100 may be implemented by at least one application specific integrated circuit (ASIC), digital signal processor (DSP), digital signal processing device (DSPD), programmable logic device (PLD), field programmable gate array (FPGA), controller, microcontroller, microprocessor, or other electronic components to perform the methods herein.

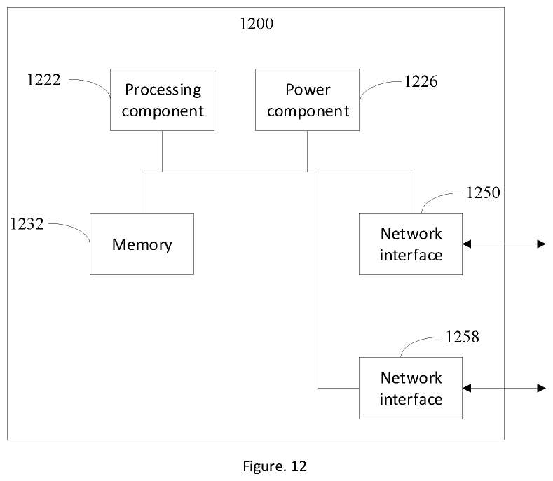

FIG. 12 is a block diagram of a network-side device 1200 provided by an example of the disclosure. For example, the network-side device 1200 may be provided as a network-side device. Referring to FIG. 12, the network-side device 1200 includes a processing component 1222, which further includes at least one processor (not shown), and a memory resource represented by a memory 1232 for storing instructions, such as an application program, executable by the processing component 1222. The application program stored in the memory 1232 may include one or more modules each of which corresponds to a set of instructions. In addition, the processing component 1222 is configured to execute the instructions to execute any of the included methods performed by the network-side device, such as the method shown in FIG. 1.

The network-side device 1200 may also include a power component 1226 configured to perform power management of the network-side device 1200, a wired or wireless network interface 1250 configured to connect the network-side device 1200 to a network, and an input/output (I/O) interface 1258. The network-side device 1200 may operate an operation system stored in the memory 1232, such as Windows Server™, Mac OS X™, Unix™, Linux™, Free BSD™ or the like.

In the included examples provided by the disclosure, the methods provided by the examples of the disclosure are introduced respectively from the perspectives of the network-side device and the UE. In order to implement the functions in the methods provided by the examples of the disclosure, the network-side device and the UE may include a hardware structure and a software module, and the functions are implemented through the hardware structure, the software module or a form of the hardware structure and the software module. A certain function of the included functions may be executed through the hardware structure, the software module, or the form of the hardware structure and the software module.

An example of the disclosure provides a communication apparatus. The communication apparatus may include a transceiver module and a processing module. The transceiver module may include a sending module and/or a receiving module, the sending module is configured to implement a sending function, the receiving module is configured to implement a receiving function, and the transceiver module may implement the sending function and/or the receiving function.

The communication apparatus may be user equipment (such as the user equipment in the example of the included methods), may also be an apparatus in the user equipment, and may further be an apparatus that may be used in cooperation with the user equipment. Alternatively, the communication apparatus may be a network device, may also be an apparatus in the network device, and may further be an apparatus used in cooperation with the network device.

An example of the disclosure provides another communication apparatus. The communication apparatus may be a network device, may also be the user equipment (such as the user equipment in the example of the included methods), may also be a chip, a system on chip, or a processor, etc. that supports the network device to implement the methods herein, and may further be a chip, a system on chip, or a processor, etc. that supports the user equipment to implement the included methods. The apparatus may be configured to implement the methods described in the examples of the included methods, which may specifically refer to the descriptions in the example of the included methods.

The communication apparatus may include one or more processors. The processor may be a general purpose processor or a special purpose processor. For example, the processor may be a baseband processor or a central processing unit. The baseband processor may be configured to process communication protocols and communication data, and the central processing unit may be configured to control the communication apparatus (such as the network-side devices, a baseband chip, the user equipment, a user equipment chip, a DU or a CU, etc.), to execute a computer program and process data of the computer program.

Alternatively or additionally, the communication apparatus may also include one or more memories on which the computer programs may be stored, and the one or more processors collectively execute the computer programs to cause the communication apparatus to perform the methods described in the examples of the included methods. Alternatively or additionally, data may also be stored in the memory. The communication apparatus and the memory may be set up separately or may also be integrated together.

Alternatively or additionally, the communication apparatus may also include a transceiver and an antenna. The transceiver may be called a transceiver unit, a sending and receiving machine, or a transceiver circuit, etc., and configured to achieve sending and receiving functions. The transceiver may include a receiver and a sender, and the receiver may be called a receiving machine or a receiving circuit, etc., and configured to implement the receiving function; and the sender may be called a sending machine or a sending circuit, etc., and configured to implement the sending function.

Alternatively or additionally, the communication apparatus may also include one or more interface circuits. The interface circuit is configured to receive code instructions and transmit them to the one or more processors. The one or more processors collectively execute the code instructions to cause the communication apparatus to perform the method described in the examples of the included methods.

The communication apparatus is the user equipment (such as the user equipment in the examples of the methods herein). The one or more processors are collectively configured to perform any method in FIG. 1 to FIG. 4

The communication apparatus is the network device. The transceiver is configured to perform any method in FIG. 5 to FIG. 7.

In an implementation, the one or more processors may include the transceiver configured to implement receiving and sending functions. For example, the transceiver may be the transceiver circuit or an interface or the interface circuit. The transceiver circuit or the interface or the interface circuit configured to implement the receiving and sending functions may be separated and may also be integrated. The transceiver circuit or the interface or the interface circuit may be configured to read and write the codes/data, or the transceiver circuit or the interface or the interface circuit may be configured to transmit or transfer signals.

In an implementation, the one or more processors may store the computer programs, which runs on the one or more processors, so as to enable the communication apparatus to perform the method described in the examples of the included methods. The computer programs may be firmed in the processor, and in this case, the processor may be implemented through hardware.

In an implementation, the communication apparatus may include a circuit that may implement the functions of sending or receiving or communicating in the examples of the methods herein. The processor and the transceiver described in the disclosure may be implemented in an integrated circuit (IC), an analog IC, a radio frequency integrated circuit (RFIC), a mixed signal IC, an application specific integrated circuit (ASIC), a printed circuit board (PCB), an electronic device, etc. The processor and the transceiver may also be manufactured with various IC process technologies, such as a complementary metal oxide semiconductor (CMOS), an nMetal-oxide-semiconductor (NMOS), a positive channel metal oxide semiconductor (PMOS), a bipolar junction transistor (BJT), a bipolar CMOS (BiCMOS), silicon germanium (SiGe), gallium arsenide (GaAs), etc.

The communication apparatus in the description of the included examples may be the network device or the user equipment (such as the user equipment in the examples of the methods), but the scope of the communication apparatus described in the disclosure is not limited to this. A structure of the communication apparatus may not be restricted. The communication apparatus can be an independent apparatus or part of a larger device. For example, the communication apparatus may be: (1) an independent integrated circuit IC or a chip or a system on chip or a subsystem; (2) a set with one or more ICs, where alternatively or additionally the set of the ICs may also include a storage component configured to store the data and the computer program; (3) the ASIC, for example, a modulator-demodulator (Modem); (4) a module able to be embedded in other devices; (5) the transceiver, the terminal device, smart terminal device, a cellular phone, a wireless device, a handset, a mobile unit, a vehicle-mounted device, the network device, a cloud device, an artificial intelligence device, etc.; and (6) others.

In the case that the communication apparatus may be the chip or the system on chip, the chip includes a processor and an interface. The quantity of the processors may be one or more, and the quantity of the interfaces may be more.

Alternatively or additionally, the chip further includes a memory, configured to store computer programs and data.

Those skilled in the art can also understand that various illustrative logical blocks and steps listed in the examples of the disclosure may be implemented by electronic hardware, computer software, or a combination of the two. Whether such function is implemented through the hardware or the software depends on the specific application and design requirements of an overall system. Those skilled in the art can use a variety of methods to implement the function for each particular application, but such implementation is not to be construed as departing from the scope of the protection of the examples of the disclosure.

An example of the disclosure also provides a system for determining a duration of a side link. The system includes the communication apparatus used as the user equipment (such as the user equipment in the example of the included methods) and the communication apparatus as the network device in the included examples, or, the system includes the communication apparatus used as the user equipment (such as the user equipment in the example of the included methods) and the communication apparatus as the network device in the included examples.

The disclosure further provides a non-transitory computer readable storage medium on which instructions is stored, and the instructions, when executed by a computer, implements functions of an example of any method herein.

The disclosure further provides a computer program product, and the computer program product, when executed by a computer, implements functions of an example of any included method.

The examples herein may be implemented in whole or in part by software, hardware, firmware, or any combination of them. When the examples are implemented by using software, the examples may be implemented in whole or in part in a form of the computer program product. The computer program product includes one or more computer programs. When the computer program is loaded and executed on a computer, the flows or functions described in accordance with the examples of the disclosure are produced in whole or in part. The computer may be a general purpose computer, a special purpose computer, a computer network, or other programmable apparatuses. The computer program may be stored in the computer readable storage medium or transmitted from one computer readable storage medium to another computer readable storage medium, for example, the computer program may be transmitted from a website, computer, server, or data center to another website, computer, server, or data center via a wired (e.g., a coaxial cable, an optical fiber and a digital subscriber line (DSL)) or a wireless (e.g., infrared, wireless and microwaves) way. The non-transitory computer readable storage medium may be any available medium accessible by the computer or a data storage device such as a server and a data center including one or more integrated available media. The available medium may be a magnetic medium (e.g., a floppy disk, a hard disk and a magnetic tape), an optical medium (e.g., a high-density digital video disc (DVD)), a semiconductor medium (e.g., a solid state disk (SSD)), or the like.

Those ordinarily skilled in the art can understand that first, second and other various ordinal numerals involved in the disclosure are distinguished merely for the purpose of convenient description instead of being used for limiting the scope of the examples of the disclosure, and may also represent a sequential order.

“At least one” in the disclosures may also be described as “one or more”, and more may be two, three, four or more, which is not limited in the disclosure. In the examples of the disclosure, for a technical feature, technical features of the technical feature are distinguished by “first”, “second”, “third”, “A”, “B”, “C”, “D”, etc., and the technical features described by the “first”, “second”, “third”, “A”, “B”, “C”, and “D” have no order of precedence or magnitude.

After considering the specification and the practicing the disclosure disclosed here, those skilled in the art will easily think of other implementation solutions of the disclosure. The disclosure is intended to cover any variation, use or adaptive change of the disclosure, these variations, uses or adaptive changes follow general principles of the disclosure and include common knowledge or customary technical means in the technical field not disclosed in the disclosure. The specification and the examples are merely regarded as examples, and the true scope and spirit of the disclosure are indicated by the claims below.

It is to be understood that the disclosure is not limited to a precise structure already described herein and shown in the accompanying drawings and various modifications and changes can be made without departing from the scope of the disclosure. The scope of the disclosure is limited only by the appended claims.

1. An on-demand positioning reference signal (PRS) request method, performed by a user equipment (UE), and comprising:
sending at least one of an on-demand PRS request or auxiliary information to a network-side device via a mobile original-location request (MO-LR) request message; and
receiving PRS configuration information sent based on the MO-LR request message by the network-side device.

2. The method according to claim 1, wherein the on-demand PRS request comprises at least one of the following:
a PRS configuration requested by the UE;
a PRS configuration identification requested by the UE; or
first indication information, used for indicating the UE to request the network-side device to send the PRS configuration information.

3. The method according to claim 1, wherein
the auxiliary information is used by the network-side device to determine the PRS configuration information corresponding to the UE; and
the auxiliary information comprises at least one of the following:
rough location information of the UE,
reference signal quality,
line of sight (LOS) indication information, or
non line of sight (NLOS) indication information.

4. The method according to claim 2, wherein sending at least one of the on-demand PRS request or the auxiliary information to the network-side device via the MO-LR request message comprises:
sending the MO-LR request message to the network-side device based on a system message broadcast by the network-side device, and
wherein the MO-LR request message comprises
at least one of the on-demand PRS request or the auxiliary information, or
not comprising the on-demand PRS request or the auxiliary information.

5. The method according to claim 4, wherein sending the MO-LR request message to the network-side device based on the system message broadcast by the network-side device comprises at least one of the following:
determining whether at least one of the on-demand PRS request or the auxiliary information are/is comprised in the MO-LR request message based on whether a positioning system message broadcast by the network-side device comprises at least one of PRS configuration information or PRS configuration information for an on-demand PRS; or
sending the MO-LR request message to the network-side device based on whether the system message comprises second indication information, wherein the second indication information is used for indicating the UE to be capable of sending the on-demand PRS request to the network-side device;
wherein the MO-LR request message sent by the UE to the network-side device comprises at least one of the on-demand PRS request or the auxiliary information in response to determining that the system message comprises the second indication information, or the MO-LR request message sent by the UE to the network-side device does not comprise the on-demand PRS request or the auxiliary information in response to determining that the system message does not comprise the second indication information.

6. The method according to claim 5, wherein determining whether at least one of the on-demand PRS request or the auxiliary information are/is comprised in the MO-LR request message based on whether the positioning system message broadcast by the network-side device comprises at least one of the PRS configuration information or the PRS configuration information for the on-demand PRS comprises:
the MO-LR request message sent by the UE to the network-side device comprising the on-demand PRS request in response to determining that the positioning system message does not comprise the PRS configuration information, wherein the on-demand PRS request comprises the first indication information;
the MO-LR request message sent by the UE to the network-side device not comprising the on-demand PRS request or the auxiliary information in response to determining that the positioning system message does not comprise the PRS configuration information;
the MO-LR request message sent by the UE to the network-side device not comprising the on-demand PRS request or the auxiliary information in response to determining that the positioning system message does not comprise the PRS configuration information for the on-demand PRS;
the MO-LR request message sent by the UE to the network-side device comprising at least one of the on-demand PRS request or the auxiliary information in response to determining that the positioning system message comprises the PRS configuration information, but does not comprise the PRS configuration information for the on-demand PRS, wherein the on-demand PRS request comprises the PRS configuration requested by the UE; and
the MO-LR request message sent by the UE to the network-side device comprising at least one of the on-demand PRS request or the auxiliary information in response to determining that the positioning system message comprises the PRS configuration information for the on-demand PRS.

7. The method according to claim 6, wherein
at least one of the PRS configuration or the PRS configuration identification requested by the on-demand PRS request correspond to the PRS configuration information for the on-demand PRS in the positioning system message in response to determining that the MO-LR request message sent by the UE to the network-side device comprises at least one of the on-demand PRS request or the auxiliary information.

8. (canceled)

9. The method according to claim 5, wherein the system message is a positioning system message.

10. The method according to claim 1, wherein a method of sending at least one of the on-demand PRS request or the auxiliary information to the network-side device via the mobile original-location request (MO-LR) request message comprises at least one of the following:
comprising at least one of the on-demand PRS request and the auxiliary information in a long term evolution positioning protocol packet data unit (LPP PDU) of the MO-LR request message, and sending the MO-LR request message to the network-side device, or
adding an information element (IE) in the MO-LR request message, using the added IE to carry at least one of the on-demand PRS request or the auxiliary information, and sending the MO-LR request message to the network-side device.

11. The method according to claim 1, wherein a method of receiving the PRS configuration information sent based on the MO-LR request message by the network-side device comprises at least one of the following:
receiving the PRS configuration information sent by the network-side device, wherein the PRS configuration information is the same as a PRS configuration requested by the UE,
receiving the PRS configuration information sent by the network-side device, wherein the PRS configuration information is different from the PRS configuration requested by the UE, or
not receiving the PRS configuration information sent by the network-side device.

12. An on-demand positioning reference signal (PRS) request method, performed by a network-side device and comprising:
receiving at least one of an on-demand PRS request or auxiliary information sent via a mobile original-location request (MO-LR) request message by UE; and
sending PRS configuration information to the UE based on the MO-LR request message.

13. The method according to claim 12, wherein the on-demand PRS request comprises at least one of the following:
a PRS configuration requested by the UE,
a PRS configuration identification requested by the UE, or
first indication information, used for indicating the UE to request the network-side device to send the PRS configuration information,
wherein the auxiliary information is used by the network-side device to determine the PRS configuration information corresponding to the UE, and
wherein the auxiliary information comprises at least one of the following:
rough location information of the UE,
reference signal quality,
line of sight (LOS) indication information, or
non line of sight (NLOS) indication information.

14. (canceled)

15. The method according to claim 13, further comprising:
broadcasting a positioning system message to the UE, wherein the positioning system message comprises at least one of PRS configuration information or PRS configuration information for an on-demand PRS, or the positioning system message does not comprise the PRS configuration information or the PRS configuration information for the on-demand PRS.

16. The method according to claim 15, wherein receiving at least one of the on-demand PRS request or the auxiliary information sent via the MO-LR request message by the UE comprises at least one of the following:
receiving the on-demand PRS request sent via the MO-LR request message by the UE, wherein the on-demand PRS request comprises the first indication information, or
receiving at least one of the on-demand PRS request or the auxiliary information sent via the MO-LR request message by the UE in response to determining that the positioning system message broadcast by the network-side device comprises the PRS configuration information for the on-demand PRS, wherein the at least one of the PRS configuration or the PRS configuration identification requested by the on-demand PRS request are at least one of a PRS configuration or a PRS configuration identification corresponding to the PRS configuration information for the on-demand PRS in the positioning system message broadcast by the network-side device,
wherein a method of sending the PRS configuration information to the UE based on the MO-LR request message comprises at least one of the following:
sending PRS configuration information the same as the PRS configuration requested by the UE to the UE in response to determining that the MO-LR request message sent by the UE to the network-side device comprises at least one of the on-demand PRS request or the auxiliary information, and the PRS configuration and/or the PRS configuration identification requested by the on-demand PRS request are/is the PRS configuration and/or the PRS configuration identification corresponding to the PRS configuration information for the on-demand PRS in the positioning system message,
sending the PRS configuration information to the UE in response to determining that the MO-LR request message sent by the UE to the network-side device comprises at least one of the on-demand PRS request or the auxiliary information, and the on-demand PRS request merely comprises the PRS configuration requested by the UE, the PRS configuration information sent by the network-side device to the UE being different from the PRS configuration requested by the UE,
sending the PRS configuration information to the UE based on the first indication information in response to determining that the MO-LR request message sent by the UE to the network-side device merely comprises the on-demand PRS request, and the on-demand PRS request comprises the first indication information, or
skipping sending the PRS configuration information to the UE in response to determining that the network-side device does not support sending the PRS configuration information.

17-19. (canceled)

20. The method according to claim 13, further comprising:
broadcasting a system message to the UE, wherein the system message comprises second indication information, or does not comprise the second indication information, and the second indication information is used for indicating the UE to be capable of sending the on-demand PRS request to the network-side device.

21-23. (canceled)

24. A communication apparatus, comprising one or more processors and a memory, wherein the memory stores computer programs, and the one or more processors are collectively configured to executes the computer programs stored in the memory, so as to cause the communication apparatus to perform:
sending at least one of an on-demand PRS request or auxiliary information to a network-side device via a mobile original-location request (MO-LR) request message; and
receiving PRS configuration information sent based on the MO-LR request message by the network-side device.

25. A communication apparatus, comprising one or more processors and a memory, wherein the memory stores computer programs, and the one or more processors are collectively configured to execute the computer programs stored in the memory, so as to cause the communication apparatus to perform the method according to claim 12.

26. A communication apparatus, comprising one or more processors and an interface circuit; wherein
the interface circuit is configured to receive code instructions and transmit the code instructions to the one or more processors, and
the one or more processors are collectively configured to execute the code instructions to perform the method according to claim 1.

27. A communication apparatus, comprising one or more processors and an interface circuit; wherein
the interface circuit is configured to receive code instructions and transmit the code instructions to the one or more processors, and
the one or more processors are collectively configured to execute the code instructions to perform the method according to claim 12.

28. A non-transitory computer readable storage medium, configured to store instructions, the instructions, when executed by one or more processors, causes the method according to claim 1 to be implemented by the one or more processors.

29. (canceled)
